(19) United States
(12) Patent Application Publication
(10) Pub. No.: US 2020/0081678 A1
(43) Pub. Date: Mar. 12, 2020

(54) MULTI-PANEL DISPLAY

(71) Applicant: Tribune Broadcasting Company, LLC, Chicago, IL (US)

(72) Inventor: Hank J. Hundemer, Bellevue, KY (US)

(21) Appl. No.: 16/125,329

(22) Filed: Sep. 7, 2018

(51) Int. Cl. G06F 3/14; G09G 5/00; G09G 5/393; G09G 5/395; G09G 5/12; G09G 5/02; G09G 5/38

(52) U.S. Cl. CPC G06F 3/1446; G09G 5/006; G09G 5/393; G09G 5/395; G09G 2360/04; G09G 5/02; G09G 5/38; G09G 2300/026; G09G 5/12

(57) ABSTRACT

Disclosed herein are methods and systems for displaying content on a displayable area that spans multiple panels of a multi-panel display. In an embodiment, a method includes: (i) using a genlock signal to define a periodic write interval and a periodic output interval. The method also includes: (ii) during at least a portion of the periodic write interval, using a markup document to store a frame of media content to a data storage unit. Further, the method includes: (iii) during at least a portion of the periodic output interval, using the stored frame of the media content to output the frame on at least a portion of the displayable area. Yet further, the method includes: (iv) repeating operations (ii) and (iii) for at least one or more other frames of the media content to output the media content on the displayable area.

### USAGE AND TERMINOLOGY

In this disclosure, unless otherwise specified and/or unless the particular context clearly dictates otherwise, the terms “a” or “an” mean at least one, and the term “the” means the at least one.

### SUMMARY

In one aspect, an example method of displaying content on a displayable area that spans multiple panels of a multi-panel display is disclosed. The method includes (i) using a genlock signal to define a periodic write interval and a periodic output interval; (ii) during at least a portion of the periodic write interval, using a markup document to store a frame of media content to a data storage unit; (iii) during at least a portion of the periodic output interval, using the stored frame of the media content to output the frame on at least a portion of the displayable area; and (iv) repeating operations (ii) and (iii) for at least one or more other frames of the media content to output the media content on the displayable area.

In another aspect, an example video wall system (VWS) is disclosed. The system includes a multi-panel display and a data storage unit. The system also includes a controller having one or more processors and memory storing instructions that, when executed by the one or more processors, cause the system to carry out operations including: (i) using a genlock signal to define a periodic write interval and a periodic output interval; (ii) during at least a portion of the write interval, using a markup document to store a frame of a media content to the data storage unit; (iii) during at least a portion of the output interval, using the stored frame of the media content to output the frame on at least a portion of the displayable area of the multi-panel display; and (iv) repeating operations (ii) and (iii) for at least one or more other frames of the media content to output the media content on the displayable area.

In another aspect, an example non-transitory computer-readable storage medium is disclosed. The non-transitory computer-readable storage medium having stored thereon program instructions that when executed by a processor cause performance of a set of acts including (i) using a genlock signal to define a periodic write interval and a periodic output interval; (ii) during at least a portion of the write interval, using a markup document to store a frame of a media content to a data storage unit; (iii) during at least a portion of the output interval, using the stored frame of the media content to output the frame on at least a portion of a displayable area of a multi-panel display; and (iv) repeating operations (ii) and (iii) for at least one or more other frames of the media content to output the media content on the displayable area.

### BRIEF DESCRIPTION OF THE DRAWINGS

FIG. 1 is a simplified diagram of an example video wall system.

FIG. 2A is a simplified diagram of a video wall.

FIG. 2B is a simplified diagram of desired media content to be displayed on the video wall of FIG. 2A.

FIG. 2C is a simplified diagram of the media content of FIG. 2B mapped to the video wall of FIG. 2A.

FIG. 3A is a simplified diagram of media content for output on a video wall.

FIG. 3B is a simplified diagram of media content of FIG. 3A arranged on a representation of a video wall.

FIG. 3C is a simplified diagram of a video wall displaying the media content of FIG. 3A.

FIG. 4 is a simplified diagram of a video wall system integrated within a video production system.

FIG. 5 is a simplified diagram of an example computing device.

FIG. 6 is a flowchart of an example method that may be performed by video wall systems described herein.

### DETAILED DESCRIPTION

### I. Overview

In various scenarios, it is desirable to display media content (e.g., video content, image content, etc.) on a large display, perhaps so that many people could simultaneously view the content. In one approach, the large display can be implemented by a single display panel. However, due to certain limitations of display panels, using a single display panel to display content can become increasingly difficult and/or expensive as the desired display size increases.

Another way to achieve a large display is to use a video wall that includes multiple smaller display panels that are arranged to give the impression of a large continuous display. Such an arrangement provides greater affordability and scalability than is achievable using a single large display panel. In addition, using multiple individual display panels increases the effective resolution of the assembled composite display because the number of individual pixels in the resulting composite display is generally greater, for a given total display area, than possible with a comparable single display panel.

The display panels can have thin bezels to decrease any separation between adjacent display panels so that the display can appear to be contiguous across the display panels. The display panels can also be arranged in a variety of shapes, orientations, and sizes to create a custom display. For instance, the display panels can be arranged in a 2×3 arrangement. A video wall can also include several groups of display panels, where there are gaps between the different groups, perhaps to create an artistic feature in the display. For instance, the video wall can include a first group of display panels that are arranged in a 2×3 arrangement and a second group of display panels that are arranged in a 3×3 arrangement.

The display panels of the video wall can be used to display content on a displayable area (referred to herein as a “video canvas”) formed by the displays of the display panels. In particular, the video wall can display content synchronously on any portion of the video canvas, including portions of the video canvas that span multiple display panels. In scenarios where the video wall includes several groups of display panels, content can be synchronously displayed across the groups of display panels, perhaps to create an effect that spans over a larger physical area.

A video wall can be controlled or configured using a video wall controller or processor. Currently, video wall controllers come in the form of specialized devices that can be connected to the display panels in order to control the panels. However, such specialized devices are expensive, which can make installing a video wall a costly endeavor. Additionally, video walls that are controlled by some of the specialized devices suffer from video artifacts such as low resolution (e.g., due to upscaling content) and screen tearing (e.g., due to out-of-sync videos being displayed on different display panels). Such video artifacts are particularly noticeable when an object is displayed across multiple display panels or is moving across multiple display panels.

Disclosed herein are systems and methods for displaying content on a video wall in an improved, cost-efficient, and reliable manner. In an example implementation, a system can include a video wall made up of a plurality of display panels. The video wall can be controlled and/or configured by a video wall controller. The video wall controller can be connectively coupled to each display panel, perhaps through a respective computing device connected to each display panel. In this arrangement, the system can perform methods to output content synchronously and reliably on the video wall.

The video wall controller can receive inputs indicative of a desired output to be displayed on the video canvas. For instance, a user can indicate desired content to be displayed on the video canvas. Additionally, the user can indicate a desired arrangement of the content on the video canvas. The video wall controller can use the inputs to generate a representation of the desired output. For instance, the representation could take the form of a markup document that uses layout descriptors to programmatically describe the desired output.

To display the output content as described by the markup document, the video wall controller can interpret the markup document to generate data indicative of the desired video canvas. The video wall controller can then provide the data to the display panel computing devices. The video wall controller can also use the arrangement of the display panels in physical space to generate correspondence data that maps each portion of the desired video canvas to a particular display panel. The video wall controller can provide the output data and the correspondence data to the display computing devices. The display computing devices can then use the data to cause the display panels to display the desired content on the video canvas.

In an embodiment, the output data generated by interpreting the markup document can be RBG values of the pixels of the desired video canvas. The video wall controller can provide the output data to the display panel computing devices by rendering the RBG values to a memory of a video card that can be accessed by the display panel computing devices. Each display panel computing device can use the correspondence data to determine the output data to be output by the respective display panel connected to the display panel computing device. Each display panel computing device can then cause the respective display panel to display the respective portion of the output content.

In order for the display panels to display the content synchronously, the display panel computing devices can be synchronized, perhaps using a common reference signal. For instance, the display panel computing devices can be synchronized using a genlock signal. For example, by using this technique, a vertical blanking interval of a video reference can be used to define a write interval and a read interval. During the write interval, the video wall controller can interpret the markup document and render the resulting output data to memory. And during the read interval, the display panel computing devices can read the output data from the memory and cause the display panels to synchronously display the content.

### II. Example Video Wall System

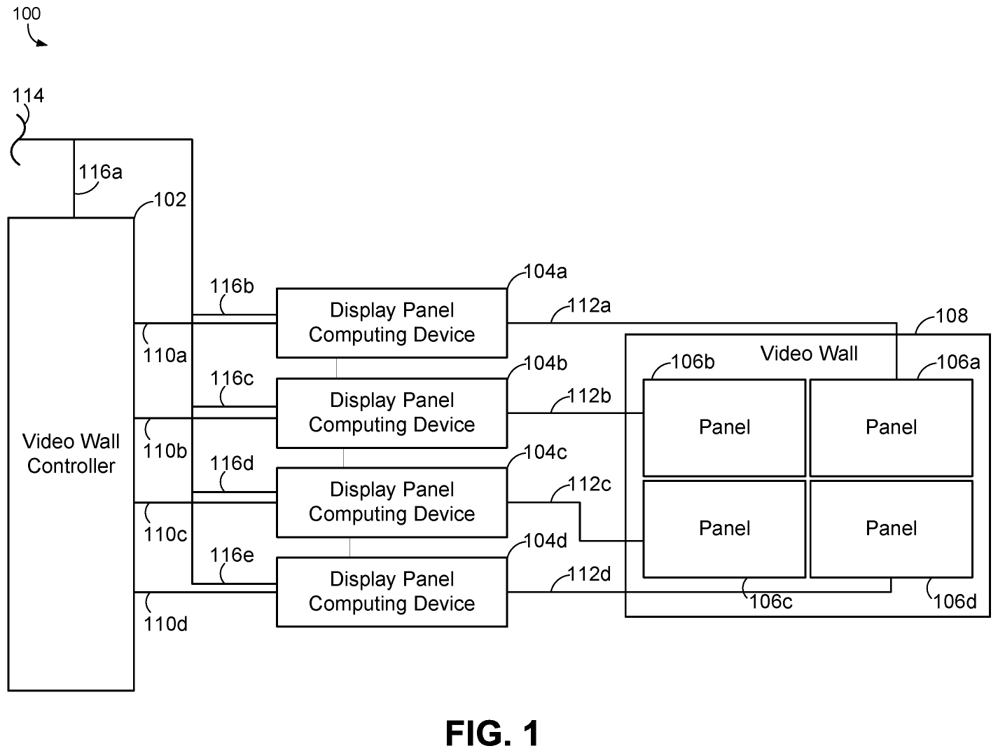

FIG. 1 is a simplified block diagram of an example video wall system (VWS) 100. The VWS 100 may be configured to perform a variety of functions related to displaying media content on a video wall 108. The VWS 100 may include one or more devices, including for example a video wall controller 102, display panel computing devices 104a-d, and/or display panels 106a-d. Note that the VWS 100 need not include all of these devices and it may include additional devices.

The systems and devices in the VWS 100 may be configured to communicate between one or more others of the devices so as to cause the VWS 100 to carry out the functions described herein. The devices of the VWS 100 described herein may communicate with each other and/or with external devices via one or more communication paths. Generally, the communication paths between devices may be provided via wired and/or wireless communication in accordance with one or more communication protocols as necessary to achieve desired performance characteristics (e.g., bandwidth, latency). For example, the video wall controller 102 and the display panel computing devices 104a-d may communicate via paths 110a-d, respectively. And the display panel computing devices 104a-d may communicate with the display panels 106a-d via paths 112a-d, respectively. These devices may communicate with each other and/or with external devices according to one or more protocols.

FIG. 1 also illustrates a signal 114 that is provided to the video wall controller 102 and the display panel computing devices 104a-d via communication paths 116a-e, respectively. The signal 114 may be a synchronization signal that is used to synchronize the devices of the VWS 100. For instance, the signal 114 may be a genlock signal that may synchronize the devices of the VWS 100, particularly the video wall controller 102 and the display panel computing devices 104a-d. The signal 114 may be an output (e.g., a video output) from a source that is integrated within or coupled to the VWS 100. Alternatively, the signal 114 may be generated by a signal generator, perhaps for the purpose of synchronizing the devices of the VWS 100. Note that other synchronization techniques are possible. As such, in some embodiments of the VWS 100, the signal 114 and/or the communication paths 116a-e may not be included in the VWS 100.

As also shown in FIG. 1, the video wall 108 is formed by display panels 106a-d that are identical in size and that are arranged symmetrically to form the video wall 108. Further, the display panels 106a-d are arranged in a single group in a 2×2 arrangement. The display panels 106a-d and the configuration of the video wall 108 shown in FIG. 1 serve as examples only. Other display panels and/or configurations may be possible. For example, the video wall 108 may include a different number of display panels and/or may include display panels that have different sizes. Additionally, the display panels may be arranged in different arrangements (e.g., asymmetrical arrangements, arrangements that form a particular shape, etc.). Further, the video wall 108 may include more than one group of display panels. For example, the video wall 108 may include a first group of display panels arranged in a 3×3 arrangement and a second group of display panels arranged nearby in a 3×1 arrangement.

Furthermore, the display panels 106a-d combine to form a displayable area on the video wall 108. This displayable area may also be referred to as a “video canvas” of the video wall 108. The resolution of the video canvas may be determined by a resolution of each display panel in the video wall 108, where the resolution of each display panel may be defined by a number of pixels in each dimension of the panel (e.g., an Ultra High Definition (UHD) display panel is defined by 3840 by 2160 pixels). As such, the resolution of the video canvas is the sum of the pixels of each display panel in each dimension. For example, a video canvas of a video wall with four UHD display panels arranged in a 2×2 arrangement may have a resolution of 7680 by 4320 pixels (also known as 8K UHD).

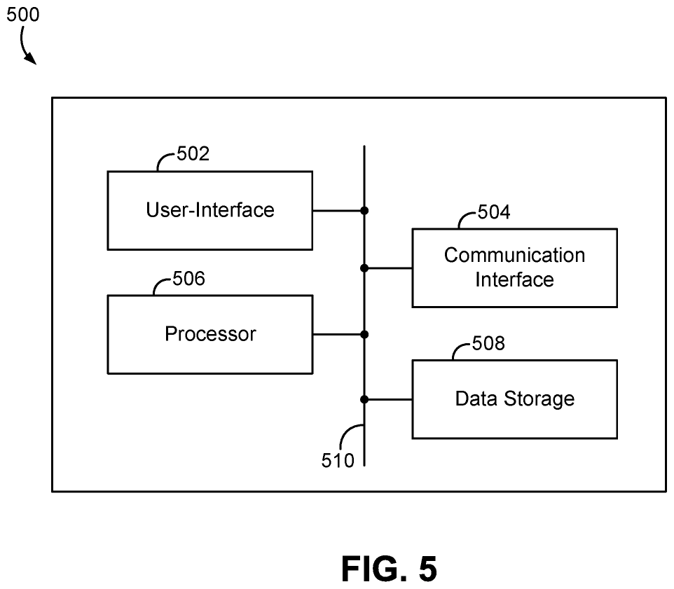

The display panels 106a-d may be configured to display media content on the video canvas of the video wall 108. In particular, the video wall controller 102 may configure and/or control the display panels 106a-d to display the media content on the video wall 108. To do so, the video wall controller 102 may be configured to perform functions related to determining a desired output to display on the video canvas, and causing the display panels 106a-d to display the desired output. The video wall controller 102 may be implemented on a computing device, such as the computing device shown in FIG. 5.

In an embodiment, the video wall controller 102 may determine the desired output from a layout descriptor document that describes the desired output. The desired output may include desired media content to be displayed on the video canvas and a layout of the media content on the video canvas. In an implementation, the layout descriptor document may be a markup document that uses a markup language and/or a style sheet language to programmatically describe the desired output. The markup language may be one of TeX, LaTeX, Extensible Markup Language (XML), XUL, XML-based languages (e.g., Scalable Vector Graphics), Hypertext Markup Language (HTML), and XHTML, among other languages. And the style sheet language may be one of Cascading Style Sheets (CSS), Document Style Semantics and Specification Language (DSSSL), Extensible Stylesheet Language (XSL), JavaScript Style Sheets (JSSS), amongother languages.

In an example, the video wall controller 102 may receive the layout descriptor document from a user. The user may create the layout descriptor document using a computing device, perhaps the video wall controller 102. In another example, the video wall controller 102 may create the layout descriptor document in response to a user input. For instance, the video wall controller 102 may display to the user a representation of the video canvas. The user may then provide inputs indicative of the desired output to be displayed on the video canvas. Based on the user inputs, the video wall controller 102 may create a layout descriptor document that describes the desired output. In yet another example, the video wall controller 102 may receive the layout descriptor document from a remote computing device (e.g., an Internet server).

In an embodiment, the description of the desired output in the layout descriptor document may include a mapping of the desired content to pixels of the video canvas. The mapping may be indicative of a position (absolute and/or relative) of the desired content on the video canvas, the resolution of the desired content, and/or the size of the desired content. The mapping may rely on a space descriptor document that describes the position of each of the display panels 106a-d in physical space. From the space descriptor document, the precise location and dimensions of the video canvas may be determined, which may be used to map the desired content to the pixels of the video canvas. Additionally, the description of the desired output in the layout descriptor document may include descriptions of the desired media content, such as a description of the desired media content's type (e.g., video, graphic, background, effect, etc.), source, time of output (e.g., commencement and conclusion time), duration of output, etc.

In line with the discussion above, the video wall controller 102 may use the layout descriptor document to provide the display panel computing devices 104a-d with data indicative of the desired output. The display panel computing devices 104a-d may use the data to cause the display panels 106a-d to display the desired output.

In an embodiment, the video wall controller 102 may use a layout descriptor language to interpret the layout descriptor document in order to determine data vectors that are indicative of the desired output. For example, the data vectors may be indicative of the pixels of the desired output to be displayed on the video canvas. For instance, the data vectors may be indicative of RGB values of the pixels of the desired output. In an implementation, each data vector may be indicative of a respective pixel of the desired output.

In an embodiment, the video wall controller 102 may interpret the layout descriptor document on a frame-by-frame basis to determine the data vectors that describe the desired output frame-by-frame. In particular, the video wall controller 102 may interpret each frame of the desired output as described by the layout descriptor document in order to determine a respective data vector for each pixel of each frame of the desired output, frame-by-frame. Doing so may allow the video wall controller 102 to provide the data vectors to the display panel computing devices 104a-d on a frame-by-frame basis so that the display panels 106a-d may display the desired output frame-by-frame.

To display a frame of the desired output, the video wall controller 102 may interpret the layout descriptor document to determine data vectors that describe the frame. The video wall controller 102 may then provide the data vectors to the display panel computing devices 104a-d, which may use the data vectors to cause the display panels 106a-d to display the frame. These steps may be performed iteratively for each frame of the content so that the display panels 106a-d may display the desired output on a frame-by-frame basis.

To provide the data vectors indicative of a frame to the display panel computing devices 104a-d, the video wall controller 102 may render the data vectors to a memory (e.g., a video card memory) that can be accessed by the computing devices 104a-d. In an implementation, the video wall controller 102 may store each data vector in a respective memory location. Thus, in the example where each data vector corresponds to a respective pixel of the frame, a number of memory locations in which the data vectors are stored may be equivalent to the number of the data vectors.

In an embodiment, the video wall controller 102 may interpret the pixels of the desired output and store the resulting data vectors in memory in a particular order. This process of interpreting the pixels of the desired output may be referred to as “writing the data vectors.” For example, the video wall controller 102 may interpret the pixels of a frame row-by-row starting from the first line of pixels of the frame. In each pixel line, the video wall controller 102 may interpret the pixels from left to right. As such, the left-most pixel in the first pixel line of the frame is interpreted first, and the right-most pixel in the last pixel line of the frame is stored interpreted last.

The video wall controller 102 may then store the resulting data vectors in memory in the same order in which the video wall controller 102 interpreted the pixels. Accordingly, the video wall controller 102 may store the data vectors in an order that mirrors the order in which the pixels that correspond to the data vectors are arranged. Specifically, the video wall controller 102 may store the data vectors in order starting with the data vectors that correspond to the first line of pixels of a frame, continuing with the data vectors that correspond to each consecutive pixel line, and ending with the data vectors that correspond to the last pixel line. When storing the data vectors that correspond to a pixel line, the data vectors are stored in order starting with the data vector that corresponds to the left-most pixel in the line and ending with the data vector that corresponds to the right-most pixel in the pixel line.

Once the data vectors indicative of the frame are rendered to memory, the display panel computing devices 104a-d may access or receive the data vectors that are stored in memory. Additionally, the display panel computing devices 104a-d may each access or receive the space descriptor document.

Each of the display panel computing devices 104a-d may use the data vectors and the space descriptor document to cause a respective display panel (coupled to the display panel computing device) to display a respective portion of the intended output. To do so, a display panel computing device may use the space descriptor document to determine the pixels of the video canvas that correspond to the respective display panel coupled to the computing device. For instance, the display panel computing device may use the descriptor document to determine the absolute coordinates of the pixels of a respective portion of the video canvas that is part of the respective display panel. The display panel computing device may then use the absolute coordinates of the pixels to determine the memory locations of the data vectors that correspond to the pixels of the desired output that will be displayed on the respective portion of the video canvas. The display panel computing device may be able to determine the memory locations of the data vectors because the data vectors were stored in a particular order by the video wall controller 102. This process of reading the data vectors from memory and causing the display panels to display the desired output may be referred to as “outputting the desired output.”

For example, the display panel computing device 104a may use the space descriptor document to determine a respective portion of the video canvas that is part of the display panel 106a. The display panel computing device 104a may determine the absolute coordinates (e.g., x,y coordinates) of the pixels of the respective portion of the video canvas. The display panel computing device 104a may then determine the data vectors that correspond to the pixels of the desired output that will be displayed on the respective portion of the video canvas.

Once the display panel computing devices 104a-d have each determined the respective data vectors, the display panel computing devices 104a-d may use the respective data vectors to cause the display panels 106a-d to display the intended content. In particular, each display panel may display the respective portion of the desired output so that the display panels 106a-d collectively display the desired output.

As explained above, the video wall controller 102 and the display panel computing devices 104a-d may be synchronized using the signal 104. In particular, a vertical blanking interval of the signal 114 may be used to define a periodic write interval and a periodic read interval. During the write interval, the video wall controller 102 may perform the processes of writing the data vectors. Specifically, during an instance of the write interval, the video wall controller 102 may interpret the layout description document to determine data vectors indicative of a frame of the desired output, and may store the resulting data vectors in memory. And during an instance of the output interval, the display panel computing devices may read the data vectors from the memory and cause the display panels to synchronously display the desired output. Additionally, because the signal 114 is used to determine when to display a frame of the desired output, the frame rate of the desired output may be the same as the frame rate of the signal 114.

### III. Example Display of Media Content on a Video Wall

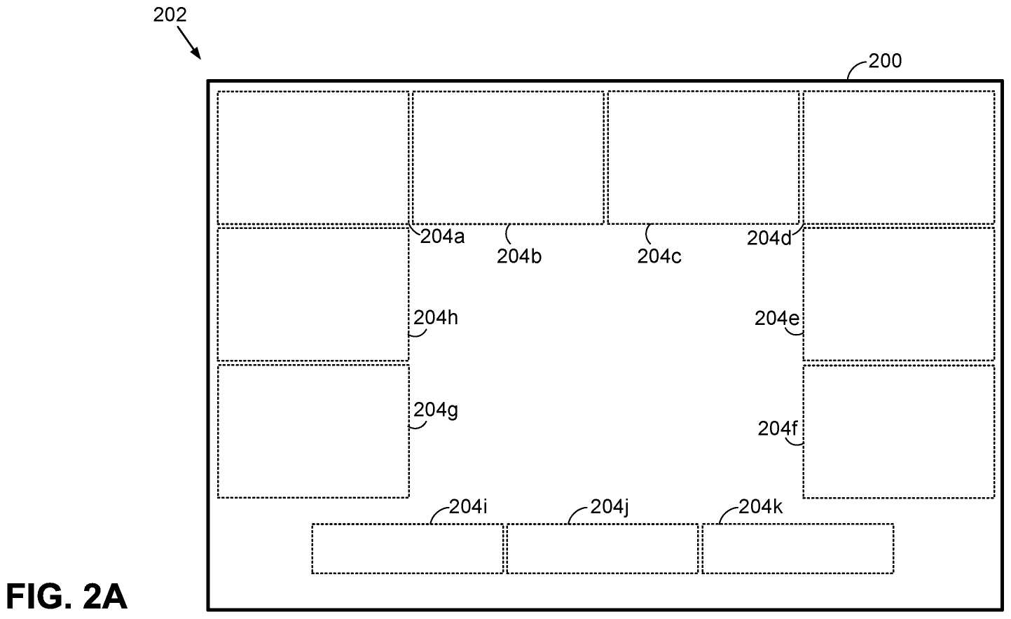

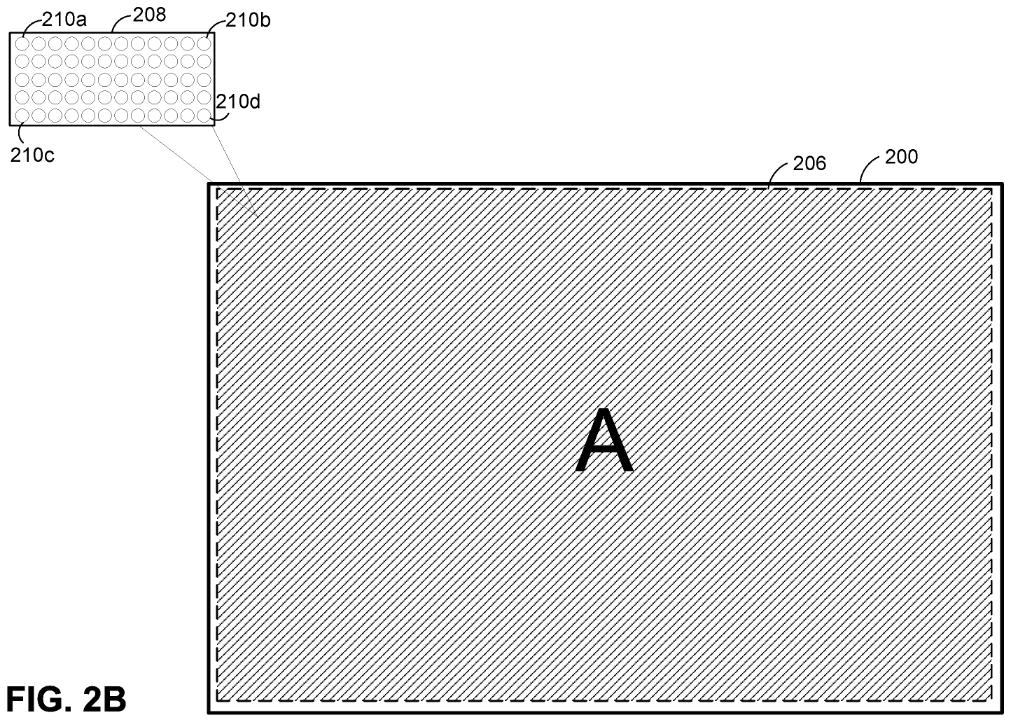

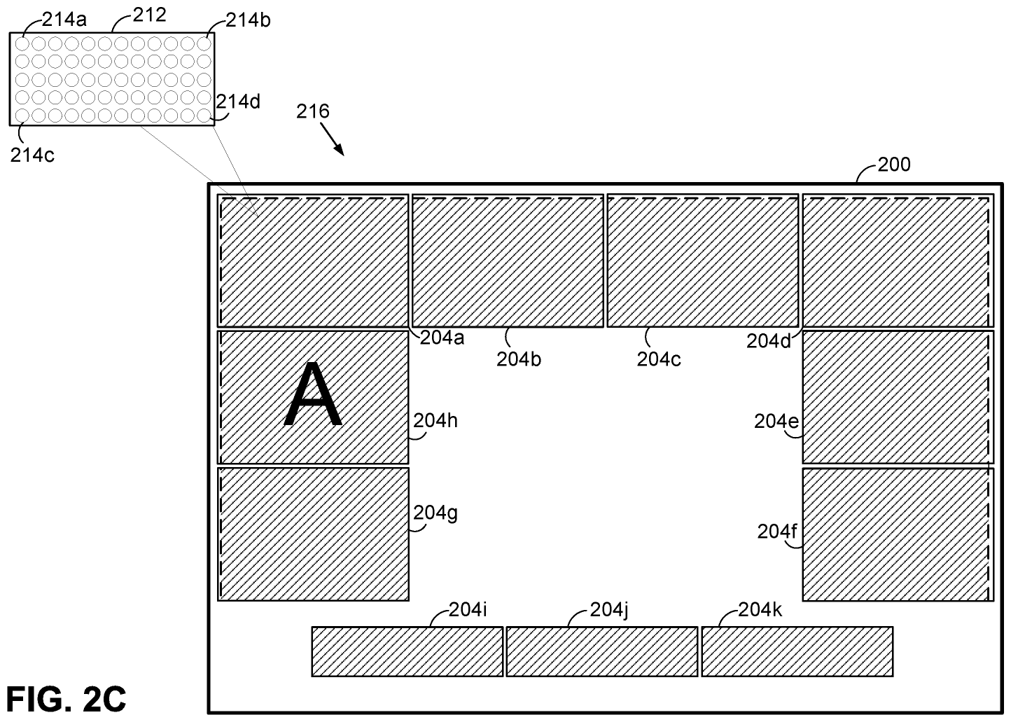

FIG. 2A illustrates a representation of a video canvas of a video wall 200 that is located in an area 202, according to an example embodiment. The video wall may be part of a video wall system, such as the VWS 100 illustrated in FIG. 1.

The video canvas is the displayable area that is formed by the displays of the display panels of the video wall 200. FIG. 2A shows representations of the display panels 204a-k of the video wall 200. As shown in FIG. 2A, the display panels 204a-k are arranged in two groups. The first group of panels includes two sets of 3×1 display panels with two display panels interspacing the top display panels of the two sets. The second group of panels includes a set of 1×3 display panels that are positioned below the first group of panels. As shown in FIG. 1, there may be a gap between the first group of panels and the second group of panels. Further, the display panels of the first group and the display panels of the second group may have different sizes. In an example, the representation of the video wall 200 may be described using a space descriptor document.

The resolution of the video canvas may be determined based on the resolution of each of the panels 204a-k. For example, the display panels 204a-g may be identical, each with a resolution of 1920×1080 pixels. And the display panels 204i-k may be identical, each with a resolution of 640×1080 pixels. Accordingly, the resolution of each set of 3×1 display panels (i.e., display panels 204a,h,g and 204d,e,f) is 5760×1080 pixels, and the combined resolution of the two interspacing panels 204b,c is 1920×2160 pixels. Further, the combined resolution of the 1×3 display panels 204i-k is 640×3240 pixels. Note that these resolutions are example resolutions and that other resolutions may be possible.

FIG. 2B illustrates desired media content 206 to be displayed on the video canvas in area 202, according to an example embodiment. The desired content 206 includes media content A, which is represented in FIG. 2B by the hashed region. In this example, the desired content 206 is video content to be displayed on the video canvas. The desired content 206 may have a particular resolution. For instance, the desired content or output 206 may have a resolution of 7000×4320 pixels. As illustrated in FIG. 2B, the desired content 206 may include a pixel array 208 that includes pixels 210a, 210b, 210c, and 210d, among other pixels.

In an embodiment, to create a layout descriptor document that describes the desired content 206, the desired content 206 may be mapped to the video canvas of the video wall 200. In particular, the pixels of the desired content or output 206 (e.g., pixels 210a-d) may be mapped to respective pixels of the video canvas. The particular pixels of the video canvas to which the pixels of the desired media content 206 are mapped may depend on a user input indicative of where the desired content 206 is arranged on the video canvas. In this example, the desired content “A” is overlaid the area 202. Thus, each pixel of the desired content 206 is mapped to a respective pixel of the video canvas that it overlays.

FIG. 2C illustrates the desired output 216, according to an example embodiment. The desired output 216 includes the desired media content 206 mapped to the video canvas of the video wall 200. In particular, the pixels of the desired content or output 206 that overlap with the video canvas are each mapped to a respective pixel of the video canvas. For example, the pixels of 210a-d of the media content “A” may overlap pixels 214a-d of the video canvas when the media content “A” is arranged on the representation of the video canvas. Accordingly, when mapping the media content “A” to the video canvas, the pixels 210a-d of the media content are mapped to the pixels 214a-d of the video canvas.

A video wall controller may interpret the layout descriptor document to determine data vectors indicative of the desired output 216. In particular, during an instance of a periodic write interval, the video wall controller may interpret the layout descriptor document to determine data vectors indicative of each pixel of a frame of the desired output 216. For example, the video wall controller may interpret the pixels of the frame starting from the top pixel line and ending with the bottom pixel line, and from the left-most pixel to the right-most pixel in each pixel line. Thus, the pixels 214a-d may be interpreted in the following order: 214a, 214b, 214c, 214d.

During the instance of the periodic write interval, the video wall controller may also store the data vectors in memory in a particular order. For example, the video wall controller may store the data vectors in an order that mirrors the order in which the pixels corresponding to the data vectors were interpreted. Accordingly, the data vector corresponding to the pixel 214a may be stored in memory before the data vector that corresponds to the pixel 214b.

Subsequently, during an iteration of a periodic read interval, display panel computing devices, each coupled to a respective one of the display panels 204a-k, may receive the data vectors indicative of the frame of the desired output 216. Additionally, the display panel computing devices may receive the space descriptor document. A display panel computing device may use the space descriptor document to determine pixels of the portion of the video canvas that is to be displayed by the respective display panel coupled to the display panel computing device. Since the data vectors are arranged in a particular order, the display panel computing device may determine the data vectors that correspond to the pixels of the portion of the video canvas to be displayed by the respective display panel. In particular, to retrieve a data vector corresponding to a pixel, the display panel computing device may use absolute coordinates of the pixel in video canvas and a byte length of the data vector to determine the memory location in which the data vector is stored. For example, assuming that pixel 214a is a first pixel of the video canvas, the pixel 214a is stored in a first memory location. The pixel 214b is the 12^{th} pixel in the video canvas. Thus, the memory location in which the pixel 214b is stored may be determined by multiplying 12 by the byte length of a data vector.

Once the display panel computing devices have each determined the respective data vectors that correspond to each respective display panel, each display panel computing device may cause the respective display panel to display the respective portion of the video canvas. The display panels may display the video canvas synchronously because the display panels are synchronized.

The processes described above may be performed iteratively for each frame of the desired output 216, perhaps for a particular period of time.

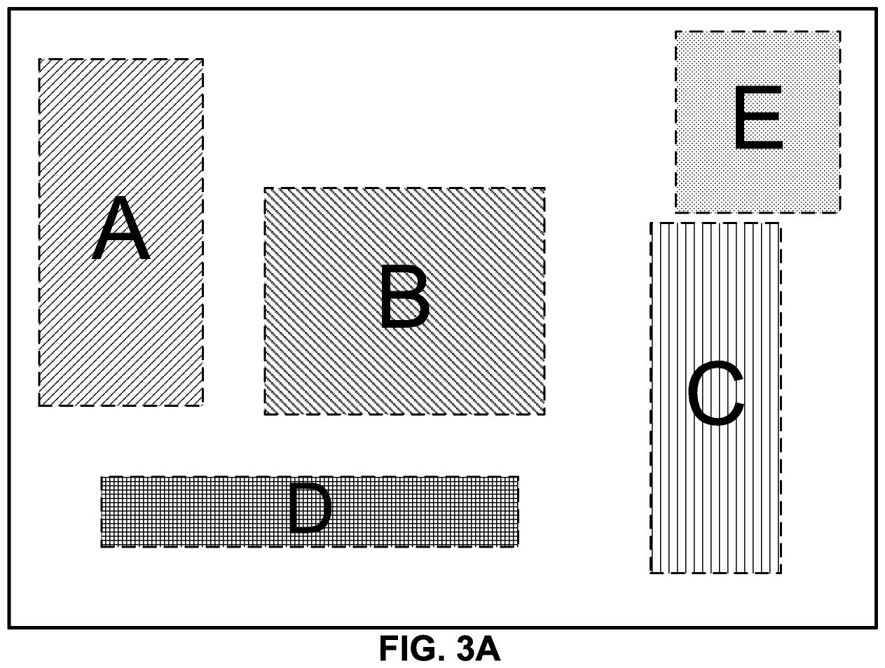

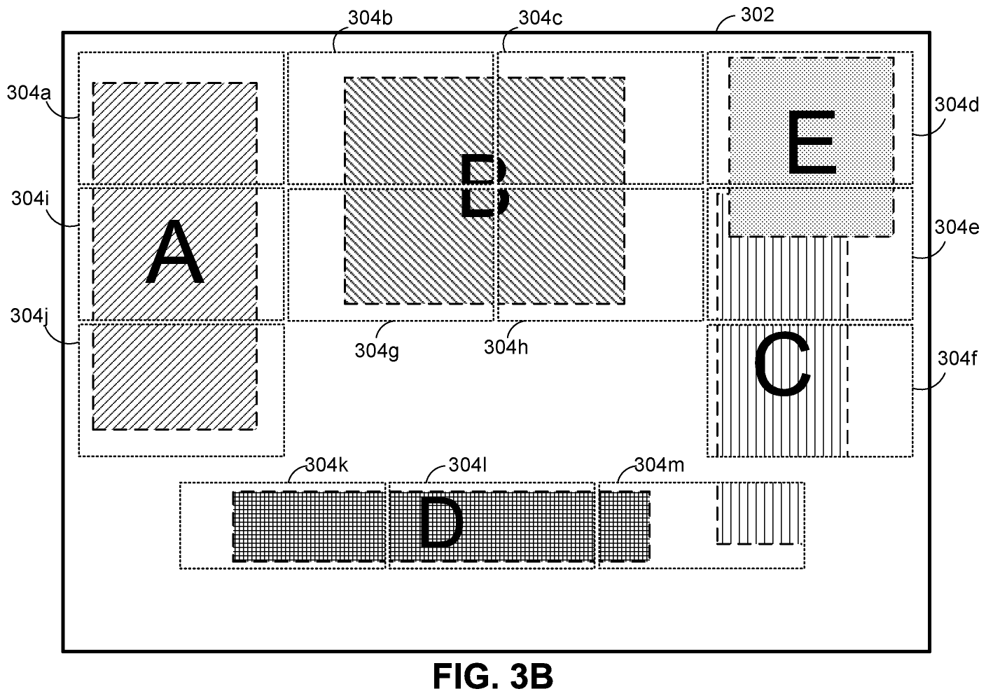

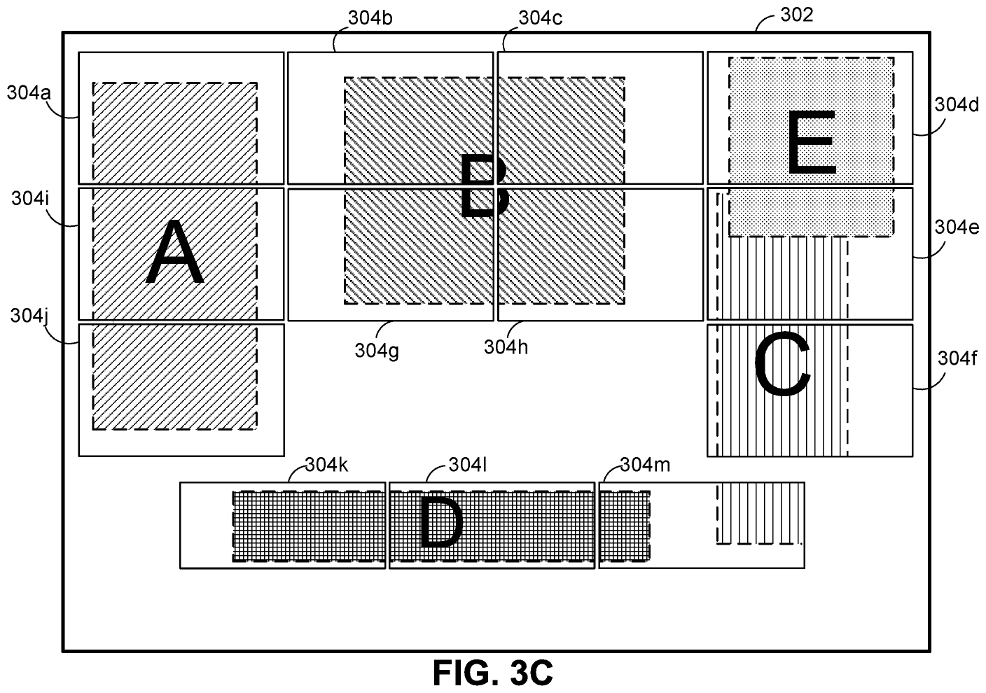

FIG. 3A illustrates a simplified diagram of media content for output on a video wall, according to an example embodiment. Each of the hashed regions in FIG. 3A may represent particular media content, such as video content, images, dynamic text, logos, or other visual content. The media content may include the content labeled as content A, B, C, D, E.

FIG. 3B illustrates a simplified diagram of the desired content arranged on a representation of a video wall 302 according to an example embodiment. As shown in FIG. 3B, the video wall 302 may include display panels 304a-m. In an embodiment, a user may indicate the particular arrangement of the desired content on the representation of the video wall 302. This representation of the desired output may be used to by a video wall system to display the desired output on the video wall 302.

FIG. 3C illustrates a simplified diagram of the video wall displaying the desired output, according to an example embodiment. As shown in FIG. 3C, the desired content may be rendered in a region that spans multiple display panels. Further still, a static or dynamic background may be included and static or dynamic text, logos, other visual content, etc., may be included on the background and/or superimposed over the clip-filled regions. Yet further, the video wall system may recognize that the media content E is overlaid the media content C, and may therefore display the media content E. This may be done by assigning the media content E a layer number that has a higher priority than the layer number of the media content C.

### IV. Example VPS

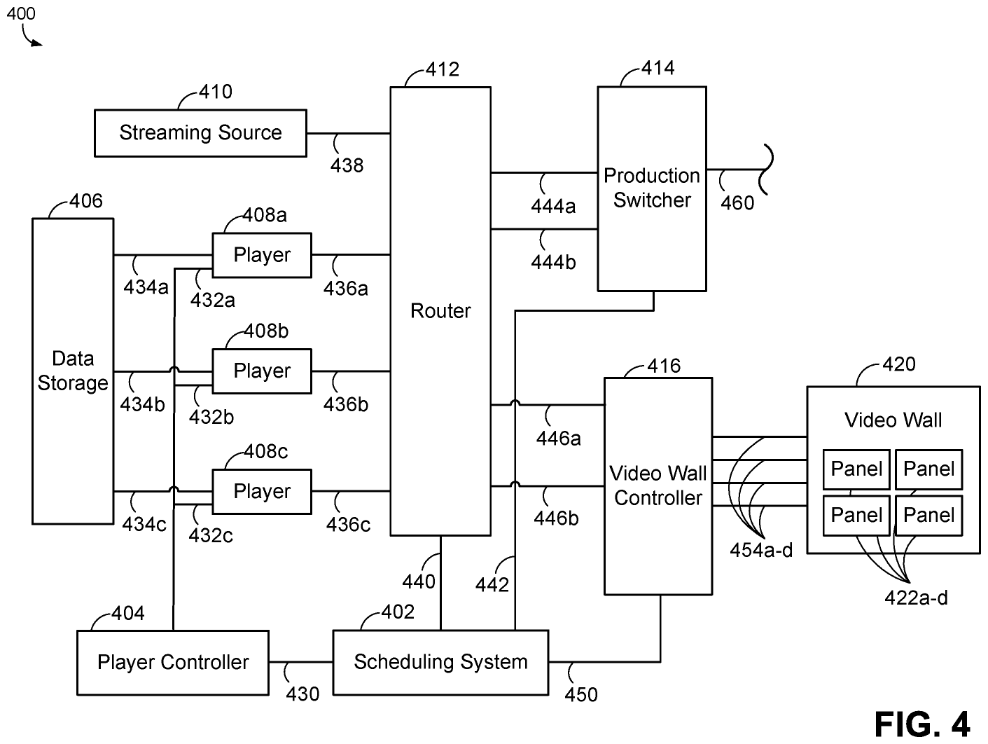

FIG. 4 is a simplified block diagram of an example video production system (VPS) 400, such as a news production system. The VPS 400 may be configured to perform a variety of functions related to producing a video program (e.g., a news program). The VPS may output the video program in video form, which in turn may be sent to a television-broadcasting system for broadcast. It is understood that the video output from the VPS 400 may be subjected to additional processing before being broadcast. For example, the video may be modified with a digital video effect (DVE) before being broadcast.

The VPS 400 may include one or more devices, including for example a scheduling system 402, a player controller 404, a data storage 406, one or more players 408a-c, a streaming source 410, a router 412, a production switcher 414, a video wall controller 416, and a video wall 420. The systems and devices in the VPS 400 are configured to communicate between one or more others of the devices so as to cause the VPS 400 to carry out the functions described herein. Note that the VPS 400 need not include all of these devices and it may include additional devices.

The devices in the VPS 400 described herein may communicate with each other and/or with external devices via one or more communication paths. Generally, the communication paths between devices may be provided via wired and/or wireless communication in accordance with one or more communication protocols as necessary to achieve desired performance characteristics (e.g., bandwidth, latency). These devices may communicate with each other and/or with external devices according to one or more protocols. For instance, in the example where the video production system is a news production system, the devices may communicate in accordance with one or more versions of the Media Object Server (MOS) protocol.

As shown in FIG. 4, the scheduling system 402 and the player controller 404 may communicate via path 430, the player controller 404 and the players 408a-c may communicate via respective paths 432a-c, and the players 408a-c and the data storage 406 may communicate via respective paths 434a-c. Further, the players 408a-c and the router 412 may communicate via respective paths 436a-c. The streaming source 410 and the router 412 may communicate via path 438. The router 412 may communicate with the video wall controller 416 via respective paths 446a-b, and may communicate with the production switcher 414 via respective paths 444a-b. The scheduling system 402 and the router 412 may communicate via path 440; the scheduling system 402 and the production switcher 414 can communicate via path 442. The video wall controller 416 and the video wall 420 (and the individual display panels 422a-d) may communicate via respective paths 454a-d. The scheduling system 402 and the video wall controller 416 may communicate via path 450.

A. Scheduling System

The scheduling system 402 is configured to perform functions related to scheduling and managing the production of a video program. For example, the scheduling system 402 may be configured to read a video program schedule (e.g., data that specifies an order and/or schedule of programming events involved in producing the video program). The scheduling system 402 may include a user interface to allow a user to generate the video program schedule. Once generated, the scheduling system 402 may make the video program schedule available to be accessed by other components in the VPS 400. The VPS components can then access entries in the video program schedule, select one or more entries, read data associated with those entries, and determine actions to perform based on attributes in those entries (i.e., in the received data). As a result, the various components in the VPS 400 perform various actions corresponding to each entry in the sequence indicated by the video program schedule. In some cases, the timing of each event may further be controlled, at least in part, by the scheduling system (e.g., by specifying a particular number of seconds or frame times, or another measure of time between distinct events) or perhaps a user input may indicate a start time for one or more events (e.g., to facilitate timing control by a producer or other individual).

The scheduling system 402 may be alternately referred to herein as a “sequencing system” to reflect its role in setting the sequence of various events, but not necessarily the timing of those events, which may be based on an external input (e.g., a user input). Functionality of the scheduling system 402 to effect automated control of the VPS 400 (e.g., in accordance with a predetermined scripted sequence) is described further herein.

B. Video Sources

The player controller 404 is configured to perform functions related to controlling the video players 408a-c, which are configured to retrieve, decode, and play out specified video content. Video files accessible by the players 408a-c can be stored in the data storage 406, which may be a drive array storing encoded video files. Upon retrieving and playing out selected videos, the players 408a-c can provide output video streams to the router 412. The player controller 404 can operate in accordance with signals via path 430 from the scheduling system 402. Similarly, the player controller can provide respective instructions via paths 432a-c to the players 408a-c, which cause the players 408a-c to locate and access stored video files via signals on paths 434a-c with the data storage 406. The players 408a-c can then output corresponding video streams communicated via paths 436a-c of the decoded video to the router 412.

Each player 408a-c may take a variety of forms. For instance, each player 408a-c may take the form of a video player device or a software-based video player executing on a computing device.

Additionally or alternatively, the router 412 can receive video signals via path 438 from a streaming source 410. The streaming source 410 can be configured to provide video that is received by the VPS 400 to be used substantially in real time, rather than pre-recorded video content that is stored in the data storage 406. For example, a streaming source may include live captured video from a production crew reporting in real time from a newsworthy location.

C. Router

The router 412 receives the video inputs from the players 408a-c and/or the streaming source 410, and provides video streams to the production switcher 414 and the video wall controller 418. Control signals via path 440 from the scheduling system 402 (or a sub-system controlled by the scheduling system 402) instruct the router 412 as to how to direct a given input to a given output at a given instant. For example, the router 412 may have a plurality of inputs and a plurality of outputs. At a given instant, the control signals via path 440 from the scheduling system 402 can instruct the router 412 as to which inputs (e.g., the inputs provided on paths 436a-c, 438) to map to one or more of the outputs (e.g., via the paths 444a-b, 446a-b). Video streams provided to the output ports at any given instant are thus based on one of the input streams to the router 412, with which one specified by the instructions via path 440. The router 412 thereby allows the scheduling system 402 to effect switching between different inputs to different components in the VPS 400 at different times.

D. Video Wall

The video wall 420 can include multiple display panels 422a-d positioned adjacent one another and operated to jointly render media content provided via the composite display driver. That is, the individual display panels 422a-d can operate to each display respective portions of a desired output. The resulting video wall 420 can appear similar to a single display panel that spans the region occupied by the panels 422a-d in which the separate panels 422a-d may or may not be evident. For example, the display panels 422a-d can be substantially co-planar with one another with respective active display surfaces oriented in a common direction. However, alternative configurations may also be employed.

Video wall systems offer some performance advantages in a video production system compared to a single display panel. For instance, the video production system may be a news production system that uses a camera to capture content on the video wall. In order to render video content in a manner that is readily captured by the camera, the individual display panels 422a-d are generally driven at a relatively high brightness setting to overcome washout from overhead lights. Due to the expense of display panels with high brightness capabilities, a video wall formed from multiple smaller display panels provides greater affordability and scalability than achievable using a single large display panel. In addition, using multiple individual display panels increases the effective resolution of the assembled composite display because the number of individual pixels in the resulting video wall is generally greater, for a given total display area, than possible with a comparable single display panel. Video walls therefore mitigate pixilation and distortions even when a variety of camera perspectives are captured, including shots that zoom in on a sub-portion of the composite display.

A video wall controller 416 is provided to operate the video wall 420. The video wall controller 416 may operate in accordance with instructions sent from the scheduling systems 402. As such, the video wall 420, and the content rendered on the video wall 420, can be controlled by the scheduling system 402 (e.g., specified by a video program schedule or another predetermined sequence). The video wall controller 416 may provide instructions and/or other data on paths 454a-d for the individual display panels 422a-d in the video wall 420 so that the panels 422a-d jointly render an intended output media stream. video wall controller 416 may be configured to operate a given one of the display panels 422a-d to display a respective portion (e.g. a sub-frame) of an output video stream such that the individual panels 422a-d in the video wall 420 are operated in coordination to jointly render the output video stream.

The video wall controller 416 may also be configured to apply a DVE to the incoming video stream(s). For example, the video wall controller 416 may be configured to apply scaling, positioning, perspective, shading, color-correction, and/or other DVEs to one or multiple input video streams provided by the router 412. In one example, the intended output media stream for the video wall 420 may include multiple scaled framed windows overlaid on a background populated by scrolling text. Each window of media content can have a scaling, perspective, and position on the video wall 420 specified by signals from the video wall controller 416, which operates in accordance with instructions from the scheduling system 402.

E. Production Switcher

The production switcher 414 receives video inputs and uses the video input stream to generate a video output stream from the VPS 400, on path 460. The scheduling system 402 can provide instructions to the production switcher 414 via path 442 to indicate which video stream (or multiple video streams) to use to generate the output video stream on path 460. The production switcher 414 can receive video inputs from the router 412 (e.g., streaming sources and/or pre-recorded played out videos via paths 444a-b). The output video steam on path 460 may be subjected to further processing and may be passed to a broadcasting system.

In operation then, the scheduling system 402 may be configured to provide information (e.g., a video program schedule) to various components in the VPS 400 to operate such that specified stored or streamed video is rendered on the video wall 420. The video wall 420 can thereby be operated in a substantially automated fashion to render specified media content by the same scheduling system 402 that regulates operation of other devices in the VPS 400. As such, the video wall 420 can be readily integrated into the VPS 400 to render content in accordance with a predetermined script of production events to produce a video program.

In some cases, the performance of the operations described above can be carried out in response to receipt of a user input, which may be used as a timing signal to control the timing or synchronization of various events. For instance, various devices in the VPS may dynamically prime themselves to perform functions specified in a video program schedule, then prompt a user for an input, and initiate performance of those functions in response to receipt of a timing signal based on a user input. As such, a producer (or director or other personnel) may evaluate readiness to perform a given next function(s), and then, upon judging that the system is ready to proceed, provide a user input. Upon receiving the user input, the pertinent VPS devices then initiate the given function(s), perhaps after a predetermined delay interval. Thus, while not specifically illustrated in FIG. 4, one or more of the devices in VPS 400 may include (or be in communication with) a user interface that allows for receiving user inputs and perhaps for outputting information, such as diagnostic and status information, etc.

### V. Example Computing Device

FIG. 5 is a simplified block diagram of a device 500. The device 500 may take a variety of forms, including for example the scheduling system 402, the player controller 404, the data storage 406, one of the video players 408a-c, the streaming source 410, the router 412, the production switcher 414, the video wall controller 416, and/or the display panel computing devices 104a-d.

The device 500 may include various components, including for example, a user-interface 502, a communication interface 504, a processor 506, and a data storage 508, all of which may be electronically connected to each other via a system bus or other connection mechanism 510. Note that the device 500 need not include all of these components and it may include additional components.

The user-interface 502 may function to allow the device 500 to interact with a user, such as to receive input from a user and to provide output to the user. Thus, the user-interface 502 may include input components such as a computer mouse, a keyboard, or a touch-sensitive panel. The user-interface 502 may also include output components such as a display screen (which, for example, may be combined with a touch-sensitive panel) or a speaker. In some cases, the user-interface 502 may be used by a producer or other personnel to provide inputs indicative of desired output media content on a video wall.

In some cases, the user-interface 502 may be used by a producer or other personnel to provide for control of timing or synchronization of certain events performed in accordance with news program schedule entries. For instance, a producer (or director, etc.) may monitor events on a video production set, such as the readiness of other personnel for certain events to be performed and/or status indicators of various VPS sub-systems (which status indicators may be communicated using output components of the user-interface 502). Once the producer judges that the conditions are ready for performance of a next event (or sequence of events) specified by one or more news program schedule entries, the producer can provide an input using the user-interface 502 (e.g., by pressing a button). Upon receipt of data indicating the user input, the VPS can then perform the particular event(s). Such user inputs are therefore referred to herein as timing signals or initiation signals.

Moreover, in some cases events may be carried out following a predetermined delay after receipt of an initiation signal. Although in other examples, the VPS may perform events without regard to a user input. For instance, the VPS may perform a DVE and display resulting video content (or carry out another event) in response to associating a video program schedule entry (or entries) with those events. The time at which the VPS performs those events may be based on a predetermined absolute time (e.g., set by a reference clock that synchronizes VPS sub-systems), or may be based on a predetermined relative delay (e.g., a predetermined delay following execution of another event by the VPS).

The communication interface 504 may function to allow the device 500 to communicate with other devices (e.g., over the paths described above). The communication interface 504 may be configured to transmit and/or receive various types of data, including for example control data or video stream data. In one example, the communication interface 504 may take the form of a wired interface, such as an Ethernet port, USB port, or HD-SDI port. As another example, the communication interface 504 may take the form of a wireless interface, such as a WiFi interface. In either case, the communication interface 504 may include communication input and/or communication output interfaces.

The processor 506 may include one or more general purpose processors (e.g., microprocessors) and/or one or more special purpose processors (e.g., digital signal processors (DSPs), graphics processing unit (GPU), etc.). In an example, the GPU may be included in a video or graphics card of the device 500. The video card may also include a dedicated data storage unit.

The data storage 508 may include one or more volatile and/or non-volatile storage components, such as magnetic, optical, flash, or organic storage, and may be integrated in whole or in part with the processor 506. The data storage 508 may include removable and/or non-removable components. In some examples, the data storage 508 may include multiple storage drives that store data in a redundant and/or stripped configuration.

Generally, the processor 506 may be configured to execute program instructions (e.g., compiled or non-compiled program logic and/or machine code) stored in the data storage 508 to perform one or more of the functions described herein and/or shown in the accompanying drawings. As such, the data storage 508 may take the form of a non-transitory computer-readable storage medium, having stored thereon program instructions that, upon execution by the processor 506, cause the device 500 to perform one or more of the functions described herein and/or shown in the accompanying drawings.

### VI. Example Operations

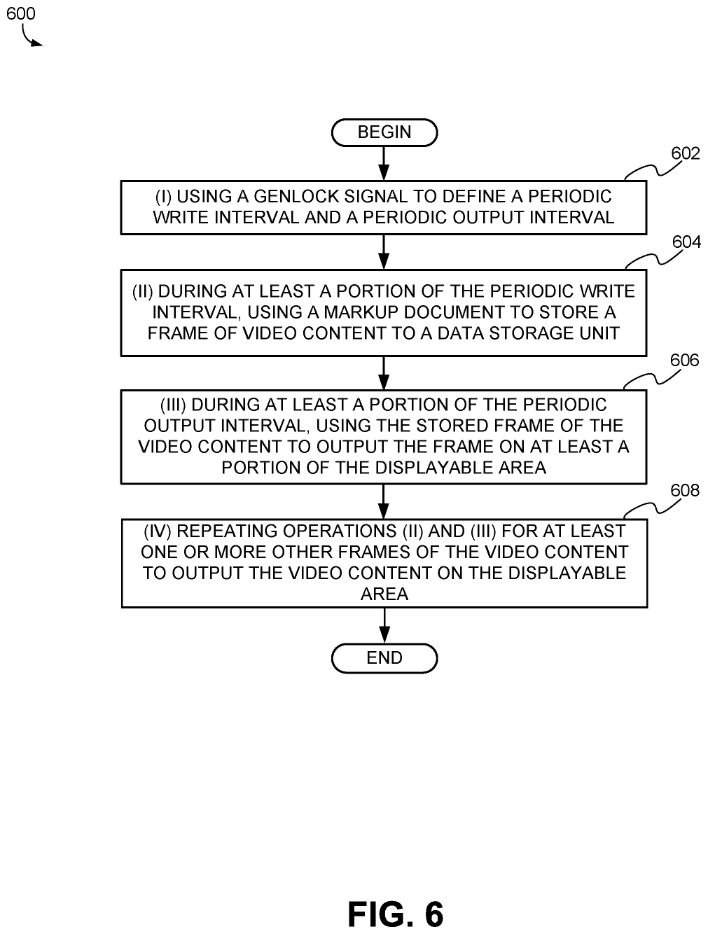

FIG. 6 is a flowchart of an example method 600 for displaying content on a multi-panel display. Method 600 is described by way of example as being implemented by the VWSs described herein. For example, the method 600 may be performed by VWS 100 described above in connection with FIG. 1 and/or the VPS 400 described above in connection with FIG. 4. However, it should be understood that method 600 could be implemented by other entities, other types of computing systems, or combinations of multiple computing systems, without departing from the scope of the invention.

At block 602, the method may involve (i) using a genlock signal to define a periodic write interval and a periodic output interval. For example, the periodic write interval and/or the periodic output interval may be defined based on a vertical blanking interval of the genlock signal.

At block 604, the method may involve (ii) during at least a portion of the periodic write interval, using a markup document to store a frame of media content to a data storage unit. The markup document may use layout descriptors to programmatically describe the media content. Using a markup document to store a frame of media content to a data storage unit may involve using a markup language to translate the layout descriptors into data vectors that are indicative of the frame of the media content, and storing each data vector in a respective location in the data storage unit. In an example, the respective location in the data storage unit is associated with a respective portion of the media content. Furthermore, each data vector may include an RGB value of a respective pixel of the frame of the media content.

At block 606, the method may involve (iii) during at least a portion of the periodic output interval, using the stored frame of the media content to output the frame on at least a portion of the displayable area. Using the stored frame of the media content to output the frame on a portion of the displayable area may involve: for each respective section of the displayable area, using a portion of the data vectors that corresponds to the respective section to output at least a portion of the frame in the respective section of the displayable area. Using the stored frame of the media content to output the frame on a portion of the displayable area may also involve using a two-dimensional (2D) space descriptor document to determine the portion of data vectors that corresponds to the respective section of the displayable area. The 2D space descriptor document may be indicative of an arrangement of the panels in physical space. Further, the 2D space descriptor document may map each data vector to the respective section of the displayable area.

At block 608, the method may involve (iv) repeating operations (ii) and (iii) for at least one or more other frames of the media content to output the media content on the displayable area. In particular, each frame of the media content may be stored to the data storage unit during a portion of a respective iteration of the periodic write interval, and each frame of the media content may be output during a portion of a respective iteration of the periodic output interval.

### VII. Example Variations

While one or more functions have been described as being performed by certain devices or entities, the functions may be performed by any device or entity, such as those included in the VWS 100 or the VPS 400 described above.

Further, while examples of the disclosed method have been described in connection with a VPS, examples of the method may be implemented in other environments.

Also, the functions need not be performed in the disclosed order, although in some examples, an order may be preferred. And not all functions need to be performed to achieve the desired advantages of the disclosed system and method, and therefore not all functions are required.

It should also be noted that the variations described in connection with select examples of the disclosed system and method may be applied to all other examples of the disclosed system or method.

### VIII. Conclusion

While select examples of the disclosed system and method have been described, alterations and permutations of these examples will be apparent to those of ordinary skill in the art. Other changes, substitutions, and alterations are also possible without departing from the disclosed system and method in its broader aspects as set forth in the following claims.

What is claimed is:

1. A method of displaying content on a displayable area that spans multiple panels of a multi-panel display, the method comprising:
(i) using a genlock signal to define a periodic write interval and a periodic output interval;
(ii) during at least a portion of the periodic write interval, using a markup document to store a frame of media content to a data storage unit;
(iii) during at least a portion of the periodic output interval, using the stored frame of the media content to output the frame on at least a portion of the displayable area; and
(iv) repeating operations (ii) and (iii) for at least one or more other frames of the media content to output the media content on the displayable area.

2. The method of claim 1, wherein the markup document uses layout descriptors to programmatically describe the media content.

3. The method of claim 1, wherein the markup document includes layout descriptors, and wherein using the markup document to store the frame of media content to the data storage unit comprises:
using a markup language to translate the layout descriptors into data vectors that are indicative of the frame of the media content; and
storing each data vector in a respective location in the data storage unit.

4. The method of claim 3, wherein the respective location in the data storage unit is associated with a respective portion of the media content.

5. The method of claim 3, wherein the markup language is a language selected from the group consisting of: TeX, LaTeX, Extensible Markup Language (XML), and Hypertext Markup Language (HTML).

6. The method of claim 3, wherein each data vector comprises an RGB value of a respective pixel of the frame of the media content.

7. The method of claim 3, wherein using the stored frame of the media content to output the frame on a portion of the displayable area comprises:
for each respective section of the displayable area, using a portion of the data vectors that corresponds to the respective section to output at least a portion of the frame in the respective section of the displayable area.

8. The method of claim 7, wherein using the stored frame of the media content to output the frame on a portion of the displayable area further comprises:
using a two-dimensional (2D) space descriptor document to determine the portion of data vectors that corresponds to the respective section of the displayable area.

9. The method of claim 8, wherein the 2D space descriptor document is indicative of an arrangement of the panels in physical space, and wherein the 2D space descriptor document maps each data vector to the respective section of the displayable area.

10. The method of claim 1, wherein each panel is controlled by a respective computing device that is coupled to the data storage unit.

11. The method of claim 1, wherein the output interval is defined based on a vertical blanking interval of the genlock signal.

12. The method of claim 1, wherein each frame of the media content is stored to the data storage unit during a portion of a respective iteration of the periodic write interval, and wherein each frame of the media content is output during a portion of a respective iteration of the periodic output interval.

13. A video wall system comprising:
a multi-panel display;
a data storage unit; and
a controller having one or more processors and memory storing instructions that, when executed by the one or more processors, cause the system to carry out operations including:
(i) using a genlock signal to define a periodic write interval and a periodic output interval;
(ii) during at least a portion of the write interval, using a markup document to store a frame of a media content to the data storage unit;
(iii) during at least a portion of the output interval, using the stored frame of the media content to output the frame on at least a portion of a displayable area of the multi-panel display; and
(iv) repeating operations (ii) and (iii) for at least one or more other frames of the media content to output the media content on the displayable area.

14. The system of claim 13, wherein the markup document uses layout descriptors to programmatically describe the media content.

15. The system of claim 13, wherein the markup document includes layout descriptors, and wherein using a markup document to store the frame of media content to the data storage unit comprises:
using a markup language to translate the layout descriptors into data vectors that are indicative of the frame of the media content; and
storing each data vector in a respective location in the data storage unit.

16. The system of claim 15, wherein the respective location in the data storage unit is associated with a respective portion of the media content.

17. The system of claim 15, wherein each data vector comprises an RGB value of a respective pixel of the frame of the media content.

18. The system of claim 15, wherein using the stored frame of the media content to output the frame on a portion of the displayable area comprises:
for each respective section of the displayable area, using a portion of the data vectors that corresponds to the respective section to output at least a portion of the frame in the respective section of the displayable area.

19. The system of claim 18, wherein during the output interval, using the stored frame of the media content to output the frame on a portion of the displayable area further comprises:
using a two-dimensional (2D) space descriptor document to determine the portion of data vectors that corresponds to the respective section of the displayable area.

20. A non-transitory computer-readable storage medium having stored thereon program instructions that when executed by a processor cause performance of a set of acts comprising:
(i) using a genlock signal to define a periodic write interval and a periodic output interval;
(ii) during at least a portion of the write interval, using a markup document to store a frame of a media content to a data storage unit;
(iii) during at least a portion of the output interval, using the stored frame of the media content to output the frame on at least a portion of a displayable area of a multi-panel display; and
(iv) repeating operations (ii) and (iii) for at least one or more other frames of the media content to output the media content on the displayable area.
